(19) United States
(12) Patent Application Publication
(10) Pub. No.: US 2003/0199214 A1
(43) Pub. Date: Oct. 23, 2003

(54) Netting for construction engineering

(75) Inventor: Tien- Pao Chiang, Taipei (TW)

Correspondence Address: BROWDY AND NEIMARK, P.L.L.C., 624 NINTH STREET, NW, SUITE 300, WASHINGTON, DC, 20001-5303, US

(73) Assignee: POLYGLAS APPLIED MATERIALS CO., LTD., Taichung (TW)

(21) Appl. No.: 10/414,279

(22) Filed: Apr. 16, 2003

(30) Foreign Application Priority Data
Apr. 18, 2002 (TW) 91205192

(51) Int. Cl. B32B 5/02; E04F 19/10

(52) U.S. Cl. 442/43

(57) ABSTRACT

A netting for construction engineering is constructed to include a net body formed of first cord member and a second cord member by weaving, the first cord member and the second cord member being respectively extended in warp sense and weft sense and respectively formed of threads of different shapes and strengths and respectively coated with a different color layer of plastic coating.

### BACKGROUND OF THE INVENTION

1. Field of the Invention

The present invention relates generally to nettings for construction engineering and, more particularly, to a netting for use in a retaining wall or the like.

2. Description of the Related Art

Regular nettings for construction engineering include hard type nettings and soft type nettings. Polypropylene, polyethylene terephthalate and high-density popyethylene are commonly used for making nettings for construction engineering. According to conventional fabrication methods, the weft and the warp of a netting for construction engineering are identical, i.e., have same color and same material. Because same material is used for the weft and the warp, the tensile strength of the netting in the transverse direction is equal to the tensile strength in the longitudinal direction. However, in actual use, it may require different tensile strengths in different directions. For example, when 90nt in warp sense and 30nt in weft sense are required, it can be achieved by using 2 threads in weft sense and 6 threads in warp sense. When 90nt in warp sense and 90nt in west sense are required, 6 threads must be used in warp sense as well as in weft sense. However, increasing the number of threads relatively increases the manufacturing cost and thickness of the netting. Further, increasing the number of threads in one direction (weft or warp sense) also relatively increases the density of the meshes. If the size of the meshes of a netting is excessively small, the soil retaining effect of the netting will be poor.

### SUMMARY OF THE INVENTION

The present invention has been accomplished under the circumstances in view. It is the main object of the present invention to provide a netting for construction engineering, which can conveniently be made subject to different tensile strength requirements in warp and west senses without changing the designed mesh size.

To achieve this and other objects of the present invention, the netting for construction engineering comprises a net body formed of first cord member and a second cord member by weaving, the first cord member and the second cord member being respectively extended in warp sense and weft sense and respectively formed of a plurality of threads, the net body comprising a layer of plastic coating, wherein the first cord member and the second cord member are respectively formed of different threads having different strengths.

### BRIEF DESCRIPTION OF THE DRAWINGS

FIG. 1 is a schematic drawing showing a net body for netting according to the present invention.

FIG. 2 is a sectional view taken along line 2-2 of FIG. 2.

FIG. 3 is a sectional view of a cord member for the netting according to the present invention.

FIG. 4 is a schematic drawing showing another design of net body for netting according to the present invention.

FIG. 5 shows one example of the second thread coated with a layer of plastic coating according to the present invention.

FIG. 6 shows another example of the second thread coated with a layer of plastic coating according to the present invention.

FIG. 7 shows one example of the first thread coated with a layer of plastic coating according to the present invention.

### DETAILED DESCRIPTION OF THE INVENTION

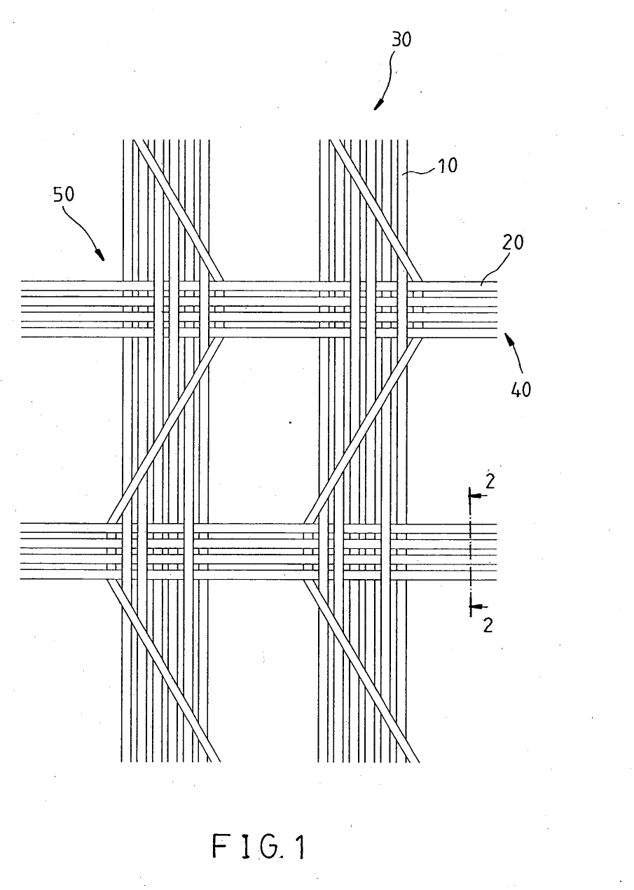

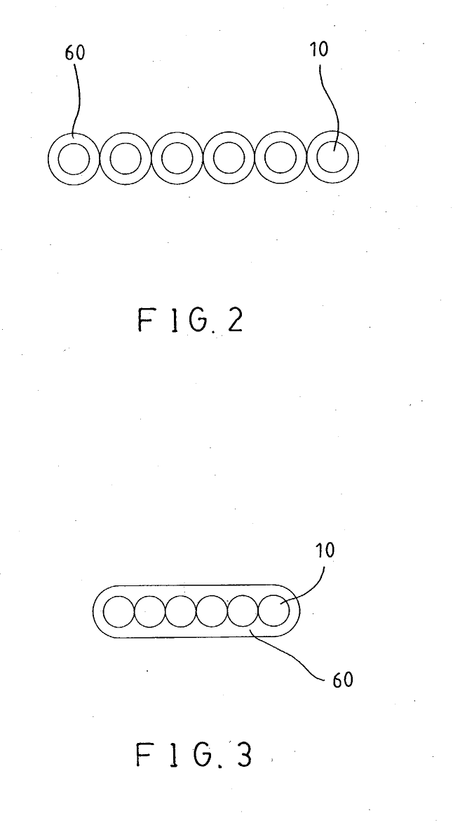

Referring to FIGS. 1˜3, a netting for construction engineering in accordance with one embodiment of the present invention is shown comprising a plurality of first threads 10 and a plurality of second threads 20. The threads 10 and 20 may be formed of organic fibers such as polyester fibers, polyamide fibers, polylefine fibers or carbon fibers, or inorganic fibers such as glass fibers, asbestos fibers. Prepared first threads 10 and second threads 20 are respectively arranged into a first cord member 30 and a second cord member 40 subject to respective predetermined strengths. For example, 3 first threads 10 of polyethylene terephthalate fibers are arranged into a first cord member 30, and 3 second threads 20 of glass fibers are arranged into a second cord member 40. Or, alternatively, 6 first threads 10 of Kevlar fibers are arranged into a first cord member 30, and 2 second threads 20 of carbon fibers are arranged into a second cord member 40. In general, the user can set the kinds of threads to be used subject to actual requirements without changing the size of the meshes of the designed netting.

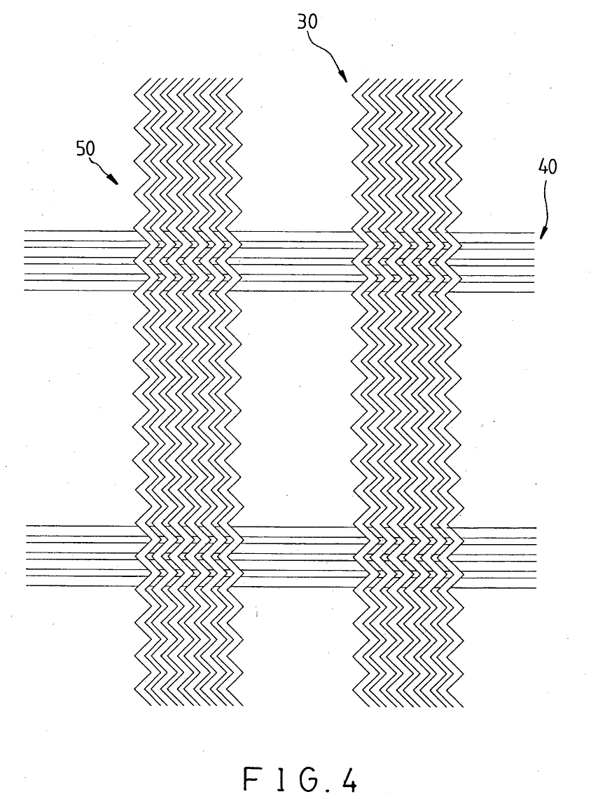

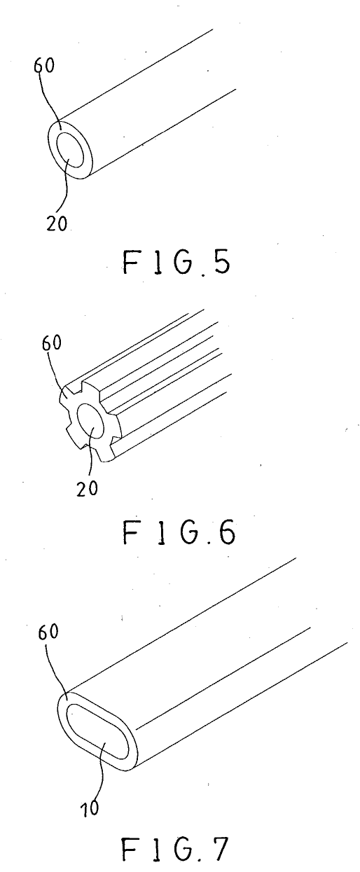

A number of prepared first cord members 30 and a number of prepared second cord members 40 are than woven into a net body 50 (see FIG. 1), and then the net body 50 is dip-coated with a layer of plastic coating 60. The plastic coating 60 can be polyvinyl chloride, polypropylene, Polyether, acrylic, or latex. Alternatively, the threads 10 (or 20) can be dip-coated with a layer of plastic coating 60 and then arranged into a cord member 30 (or 40); the cord members 30 and 40 may be separately dip-coated with a layer of plastic coating 60 and then woven into the desired net body 50 (see FIGS. 1 and 4). Further, the layer of plastic coating 60 for the first cord member 30 may be colored with a first color, and the layer of plastic coating 60 for the second cord member 30 may be colored with a second color. For example, the layer of plastic coating 60 for the first cord member 30 (warp) is colored in black color, and the layer of plastic coating 60 for the second cord member 40 (weft) is colored in red color. Further, the threads 10 and 20 can be made having any of a variety of shapes. FIGS. 5˜7 show different shape examples of the threads 10 and 20.

As indicated above, the netting for construction engineering according to the present invention has the following advantages:

1. Low Manufacturing Cost:

The manufacture can easily adjust the tensile strength of the designed netting in warp sense as well as in weft sense subject to actual requirements, so that the manufacturing cost of the desired netting can be relatively adjusted.

2. Assorted Designs:

The netting can be made of threads/cord members of different colors and shapes to fit different requirements and the different color will be a kind of sign to make the user distinguish the weft and warp easily.

A prototype of netting for construction engineering has been constructed with the features of FIGS. 1˜7. The netting for construction engineering functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A netting for construction engineering comprising a net body formed of first cord member and a second cord member by weaving, said first cord member and said second cord member being respectively extended in warp sense and weft sense and respectively formed of a plurality of threads, said net body comprising a layer of plastic coating, wherein said first cord member and said second cord member are respectively formed of different threads having different strengths.

2. The netting for construction engineering as claimed in claim 1, wherein the threads for said first cord member and said second cord member are made of materials selected from organic fibers including polyester fibers, polyamide fibers, polylefine fibers and carbon fibers.

3. The netting for construction engineering as claimed in claim 1, wherein the threads for said first cord member and said second cord member are made of materials selected from inorganic fibers including glass fibers and asbestos fibers.

4. The netting for construction engineering as claimed in claim 1, wherein said first cord member and said second cord member are dip-coated with said layer of plastic coating after having been woven into said net body.

5. The netting for construction engineering as claimed in claim 1, wherein said first cord member and said second cord member are dip-coated with said layer of plastic coating before weaving into said net body.

6. The netting for construction engineering as claimed in claim 1, wherein the threads for said first cord member and the threads for said second cord member are respectively individually dip-coated with said layer of plastic coating before weaving said first cord member and said second cord member into said net body.

7. The netting for construction engineering as claimed in claim 1, wherein the whole threads for said first cord member and the whole threads for second cord member are respectively dip-coated with said layer of plastic coating before weaving said first cord member and said second cord member into said net body.

8. The netting for construction engineering as claimed in claim 1, wherein said layer of plastic coating is selected from plastic materials including polyvinyl chloride, polypropylene, polyester, acrylics and latex.

9. The netting for construction engineering as claimed in claim 1, wherein said first cord member and said second cord member are respectively formed of different threads having different shapes.

10. The netting for construction engineering as claimed in claim 1, wherein said first cord member and said second cord member have different colors.
